(19) United States
(12) Patent Application Publication
(10) Pub. No.: US 2022/0196349 A1
(43) Pub. Date: Jun. 23, 2022

(54) COOLING DEVICE AND METHOD FOR PRODUCING IT

(71) Applicant: TRUMPF GmbH + CO. KG, Ditzingen (DE)

(72) Inventors: Mostafa Biglari, Stuttgart (DE); Christina Kotzur, Stuttgart (DE); Moritz Vogel, Stuttgart (DE)

(21) Appl. No.: 17/688,919

(22) Filed: Mar. 8, 2022

Related U.S. Application Data
(63) Continuation of application No. PCT/EP2020/075157, filed on Sep. 9, 2020.

(30) Foreign Application Priority Data
Sep. 9, 2019 (DE) 10 2019 124 110.3

(51) Int. Cl. F28F 13/18; F28F 21/08; C25D 5/34; C25D 5/48; C25D 3/46; B05D 1/28; C09D 7/61; C09D 133/12; C09D 133/26

(52) U.S. Cl. CPC F28F 13/18; F28F 21/084; F28F 21/085; C25D 5/34; C25D 5/48; F28F 2245/06; B05D 1/28; C09D 7/61; C09D 133/12; C09D 133/26; C25D 3/46

(57) ABSTRACT

A cooling device for providing passive radiation cooling includes a base substrate and a coating that is arranged on the base substrate and absorbs light of certain wavelength ranges. The base substrate is a metal substrate.

### CROSS REFERENCE TO RELATED APPLICATIONS

This application is a continuation of International Application No. PCT/EP2020/075157 (WO 2021/048177 A1), filed on Sep. 9, 2020, and claims benefit to German Patent Application No. DE 10 2019 124 110.3, filed on Sep. 9, 2019. The aforementioned applications are hereby incorporated by reference herein.

### FIELD

Embodiments of the present invention relate to a cooling device and to a method for producing it.

### BACKGROUND

To replace conventional cooling solutions, such as compression cooling, absorption cooling can be used to cool surfaces by means of what is referred to as radiation cooling. In such systems, blackbody radiation discharged by any warm body can be emitted in such a way that the body is cooled down.

Shanhui Fan et al., Nature 2014 “Passive radiative cooling below ambient air temperature under direct sunlight” describe a 1.8 μm thin coating which has alternating layers of silicon dioxide and hafnium oxide and in which a highly reflective silver layer is applied to the top side. Correspondingly, the incident sunlight can be reflected by the silver coating, and the underlying layers of silicon dioxide and hafnium oxide can absorb the heat entering at its bottom side and discharge it again in the form of radiation, the wavelength range of the discharged radiation being between 8 μm and 13 μm, that is to say within the range of an atmospheric window for this infrared radiation, such that the heat can penetrate the Earth's atmosphere and correspondingly be emitted into space, as it were.

US 2017/0248381 A1 discloses a structure in which plastic films offset by glass beads are silver-plated under reduced pressure, in order thus to apply a coating.

However, approaches for producing a cooling device that can be manufactured in a simple way are needed.

### SUMMARY

In an embodiment, the present disclosure provides a cooling device for providing passive radiation cooling. The cooling device includes a base substrate, and a coating arranged on the base substrate and configured to absorb light of certain wavelength ranges. The base substrate is a metal substrate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic sectional illustration through a cooling device according to some embodiments;

FIG. 2 shows a schematic illustration of a production line for producing a cooling device and for carrying out a production method for producing a cooling device according to some embodiments;

FIG. 3 shows a schematic illustration of an alternative production method for producing a cooling device according to some embodiments;

FIGS. 4A, 4B and 4C show a schematic illustration of a further alternative production method for producing a cooling device according to some embodiments; and

FIG. 5 shows a schematic illustration of yet another alternative production method for producing a cooling device according to some embodiments.

### DETAILED DESCRIPTION

Embodiments of the present invention provide an improved cooling device and a simplified production method for such a cooling device.

According to an embodiment, a cooling device includes a base substrate and a coating that is arranged on the base substrate and absorbs light of certain wavelength ranges. In some embodiments, the base substrate is a metal substrate.

By providing a cooling device in the manner described, it is possible to specify a simplified cooling device which, by virtue of the construction of the coating on the metal substrate, provides a particularly good heat flow for a body adjoining the metal substrate or a medium adjoining the metal substrate.

The construction on the metal substrate furthermore makes it possible to build structures directly from the cooling device itself, for example to use the proposed cooling device to construct a cooling element such as a housing for a media cooler/radiator, for example. It is correspondingly also possible to directly form a roof or a roof element from the cooling device, with the result that it is possible for the underlying house or the underlying spaces to be cooled.

By constructing the cooling device on the metal substrate, it is also possible to have the effect that the cooling device itself is particularly easy to produce, as is also evident from the following description of the production method. In particular, scalable mass production or continuous production of the cooling device can be carried out, with the result that cost-effective production of larger quantities of the proposed cooling device can be achieved.

Furthermore, the proposed cooling device can be provided in a particularly robust form, with the result that it can be used outdoors without problems and can be exposed to weather for some years while continuing to provide sufficient cooling power. The plastic films in conventional systems are only moderately weather-resistant compared to the proposed cooling device, this possibly resulting in a shorter service life.

According to various embodiments, the metal substrate can be in a form of a metal sheet and/or a metal plate and/or a metal strip. The metal sheet and/or the metal plate and/or the metal strip can comprise aluminum or an aluminum alloy or iron or an iron alloy, (e.g., steel), or copper or a copper alloy, or is an aluminum sheet or a sheet of an aluminum alloy or an iron sheet or a sheet of an iron alloy or a copper sheet or a sheet of a copper alloy.

These metals are preferred on account of their mechanical properties and producibility and processability as building material and structural material for cooling elements. In addition, the mass production of cooling devices can be achieved cost-effectively with these materials.

Furthermore, the coating of metal substrates with polymers and other metals in large-scale operation is possible and therefore scalable and cost-effective. In addition, it is possible to further machine coated metal substrates to form cooling elements and other components.

By providing the metal substrate in the form of a metal sheet or a metal plate or a metal strip, it is possible correspondingly to construct a structure which is already intrinsically mechanically stable and which correspondingly can be used to construct components, roofs, cooling elements etc. To that end, the metal substrate may for example be provided already in a curved or geometrically structured form, such as a corrugated sheet structure, for example.

Furthermore, the use of the metal sheet or the metal plate has the effect that the production resulting from the production method described below can be simplified.

A mirror coat is preferably arranged between the metal substrate and the coating provided thereon, the mirror coat having high reflectivity preferably at least at wavelengths in the visible range, in particular at wavelengths in a range of from 400 nm to 1200 nm, a silver plating in the form of a mirror coat preferably being arranged directly on the metal substrate between the metal substrate and the coating.

The application of the mirror coat between the metal substrate and the coating allows a readily scalable mirror coating step, since the mirror coat can be applied directly to the metal substrate. This can be achieved for example by virtue of known and scalable silver-plating processes, such as the use of a galvanic silver-plating process. By contrast to the conventional devices, in which complex vapor deposition under reduced pressure takes place, it is thus possible to simplify the production of the cooling device and make it scalable.

Furthermore, by virtue of being arranged between the metal substrate and the coating, the mirror coat is well protected against environmental influences, and therefore the cooling device can be correspondingly long-lasting. This results in an improvement in the durability of the cooling device in comparison with the plastic films subjected to vapor deposition that are in conventional systems.

By providing the high reflectivity in the wavelength range of visible light, it is possible for the sunlight radiating in on the cooling device to be largely reflected, with the result that it does not contribute or does not significantly contribute to heating of the cooling device. Correspondingly, it is possible to use the cooling device even under solar radiation, with the result that the proposed cooling device is particularly suitable even for mounting on house roofs etc.

In some embodiments, the transparency of the coating at wavelengths in the visible range, in particular at wavelengths in a range of from 400 nm to 1200 nm, is at least 80%, or above 90%, and or above 95%.

This makes it possible to have the effect that the sunlight radiating in on the cooling device radiates through the coating, then is reflected at the metal substrate or at the reflection layer and/or the mirror coat, and then, after it passes through the coating again, is reflected away from the cooling element. In this way, the cooling device can be readily used even when sunlight radiates in directly.

In some embodiments, the absorption of the coating at wavelengths within an atmospheric window permeable to IR radiation, in particular at wavelengths of from 7 μm to 13 μm, is at least 60%, or above 80%, and or above 90%.

In this way, heat discharged from the metal substrate or to the metal substrate from the bodies and/or media adjoining the metal substrate can be absorbed and then subsequently emitted by the cooling device again within the range of the atmospheric window permeable to infrared radiation. It is thus possible to achieve radiation cooling, since the heat present in the metal substrate is absorbed via the selective absorption of the coating and then is radiated within the range of the atmospheric window into space, as it were, with the result that there is a heat flow away from the cooling device and correspondingly heat is radiated by the metal substrate.

In this way, it is possible to have the effect that the metal substrate or the bodies and/or media adjoining the metal substrate can be kept at a temperature or brought to a temperature which is below the ambient temperature.

The coating can comprise particles and a polymer or a polymer precursor, or ceramic particles and a thermoplastic or thermosetting polymer, the particles particularly can comprise silicon dioxide and/or hafnium oxide and the polymers can comprise polymethyl acrylate, TPX or polymethylmethacrylimide.

In some embodiments, a mixing ratio is 1%-15% (percent by weight) of the ceramic particles in the polymer.

The ceramic particles can have an average particle size (D50) of between 1 μm and 20 μm, or between 7 μm and 13 μm.

This makes it possible to achieve the above-described behavior of the coating and in particular of the ceramic particles of the coating, specifically the absorption of heat or heat radiation from the metal substrate and the subsequent emission within the range of the wavelengths of the atmospheric window. At the same time, the ceramic particles can be incorporated fixedly by virtue of the polymer matrix. The provision of the polymer matrix furthermore results in a transparency of the coating within the range of the wavelengths of visible light, with the result that visible light can pass through the coating and can be reflected at the interface toward the metal substrate.

The particles and the polymer or the polymer precursor can have the same or similar refractive indices at wavelengths in the visible range, in particular at wavelengths of from 400 nm to 1200 nm, and the particles and the polymer or the polymer precursor can have divergent refractive indices at wavelengths within the atmospheric window, in particular at wavelengths of from 7 μm to 13 μm.

In some embodiments, the refractive indices diverge by less than 10%, or less than 5%, in the wavelength range of from 400 nm to 1200 nm. By contrast, in the wavelength range of from 7 μm to 13 μm the refractive indices can diverge by more than 20%, or by more than 40%.

This likewise makes it possible to achieve the desired behavior of the coating, particularly allowing visible light to pass through the coating to the metal substrate and/or to a reflection layer arranged on the metal substrate, and also the absorption and subsequent emission of radiation in the infrared range.

Correspondingly, the above-described cooling device in all of the described variants and various embodiments makes it possible to obtain radiation cooling in which heat can be transported away from the metal substrate by virtue of the emission of heat in the infrared range.

The selective absorption of the coating correspondingly makes it possible for heat energy to be selectively discharged via the cooling device.

The coating can have an embossment in order thus to further improve the absorption and emission of heat radiation. The embossment makes it possible to enlarge the effective surface in a simple manner.

A further metal layer can be arranged between the metal substrate and the reflection layer, the metal layer comprising zinc or a zinc alloy or aluminum or an aluminum alloy or tin or a tin alloy. This makes it possible to provide corrosion protection, in particular for the metal substrate.

What is correspondingly proposed is a method for producing a cooling device, for providing passive radiation cooling, comprising the steps of providing a metal substrate, preparing the metal substrate for subsequent processing, and coating the metal substrate with a coating which absorbs light of certain wavelength ranges.

This makes it possible to produce a cooling device easily and for mass manufacture.

In some embodiments, before the metal substrate is coated, a reflection layer is provided on the metal substrate and the coating is applied to the reflection layer, the reflection layer being produced by applying a silver plating to the metal substrate.

Galvanic or chemical processes are particularly preferably used to apply the reflection layer and in particular the silver plating. In this respect, the galvanic process for applying the reflection layer or depositing it in the form of a coat is particularly readily scalable, cost-effective and flexible. It is in particular the case here that the thickness of the material deposited can be very well controlled, the method can furthermore be carried out at atmospheric pressures and in a simple environment, and the method can be combined with other method steps for producing the cooling device in a continuous process.

The production of the cooling device can therefore have a particularly scalable configuration and mass production of the proposed cooling device is possible.

Before the reflection layer is applied, further coatings can be applied to the metal substrate. For example, a steel substrate with a zinc coat, a coating comprising aluminum, or a tin coat can be applied for the purpose of corrosion protection and/or to improve the interaction with and/or adhesion to the reflection layer.

The advantages already described above in relation to the cooling device are achieved by the application of the reflection layer.

The metal substrate can be cleaned in a cleaning device before it is coated, and/or polished in an electropolishing device before it is coated.

This preparation of the metal substrate simplifies the subsequent processing and it is possible to provide a surface of the metal substrate that supports the optical properties.

A coating may be applied to at least one side of the metal substrate particularly easily by means of a roll applicator. It is also possible for the coating to be applied to at least one side of the metal substrate by a coating-bar applicator or an extruder or a laminator.

The metal substrate may be provided in the form of a metal strip, for example in the form of an aluminum strip or a steel strip or a copper strip, and it can be the case that a joining device for joining metal strips that follow one another is provided.

The metal substrate provided may already comprise a coating, such as a corrosion protection means, to which the reflection layer is then applied.

In an embodiment, the metal strip coated with the coating is provided with an embossment in an embossing device.

The metal substrate may be provided in the form of a coated metal strip, for example in the form of a strip with a zinc coating or a coating comprising a zinc alloy, or with an aluminum coating or a coating comprising an aluminum alloy, or with a tin coating or a coating comprising a tin alloy, or with a magnesium coating or a coating comprising a magnesium alloy.

Exemplary embodiments are described below with reference to the figures. In this case, elements that are the same, similar or have the same effect are provided with identical reference signs in the different figures, and a repeated description of these elements is dispensed with in some instances, in order to avoid redundancies.

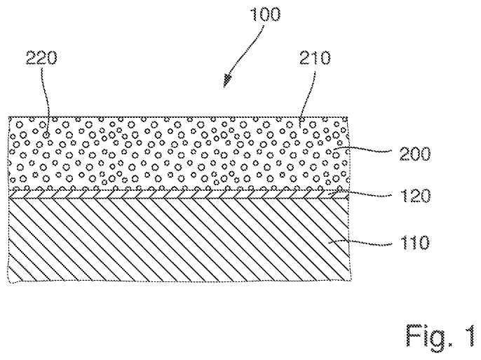

FIG. 1 shows a schematic sectional illustration through a cooling device 100, the cooling device 100 comprising a metal substrate 110, to which a coating 200 which absorbs light of certain wavelength ranges is applied.

The cooling device 100 provides passive radiation cooling.

The coating 200 may comprise a polymer matrix 210, in which ceramic particles 220 are embedded.

The metal substrate 110 can be a metal sheet or a metal plate, to which the coating 200 is applied. The metal sheet or the metal plate may be provided in the form of an aluminum structure or a steel structure or a copper structure, for example in the form of a sheet or a plate or a metal strip. The thickness of the metal substrate can be between 10 μm and 2 mm, for example between 10 μm and 0.5 mm.

The ceramic particles 220 may be provided for example in the form of silicon dioxide or hafnium oxide. The ceramic particles can have an average particle size (D50) of between 1 μm and 20 μm, for example between 7 μm and 13 μm.

The polymer matrix 210 may for example be a thermoplastic polymer or a thermosetting polymer. For example, the polymers can be polymethyl acrylate, TPX or polymethylmethacrylimide.

In some embodiments, the refractive index of the ceramic particles 220 and that of the polymer matrix 210 are selected such that, in the visible wavelength range, that is to say in a range of between 400 nm and 1200 nm, the refractive indices of the ceramic particles 220 and the polymer matrix 210 are substantially the same.

By contrast, in other ranges within other wavelength ranges, in particular within the range of an atmospheric window through which energy can be emitted into space in the infrared range, in particular in a wavelength range of between 7 μm and 13 μm, the refractive indices of the ceramic particles 220 and the polymer matrix 210 are divergent and very different. The strong diffusion of light in the wavelength range of 7 μm to 13 μm brings about the desired high emissivity in this range. In the exemplary embodiment shown in FIG. 1, a reflection layer 120, which may be realized for example in the form of a mirror coat, is provided between the coating 200 and the metal substrate 110. In the exemplary embodiment shown, the reflection layer 120 is provided in the form of a silver plating, it being possible to provide the silver plating for example by applying a thin silver-plating layer.

The silver-plating layer can be provided by galvanic or chemical means. In order to reduce the costs of producing the silver-plating layer, the silver-plating layer can be provided in a layer thickness of less than 10 μm, for example a layer thickness of less than 500 nm.

The reflection layer 120 can be formed such that it provides high reflectivity at least within the range of the visible wavelengths, that is to say between 400 nm and 1200 nm.

The proposed cooling device 100 makes it possible on the one hand to obtain increased absorption and therefore also increased subsequent emission of energy within the range of the atmospheric window, with the result that radiation cooling can be provided, by means of which heat energy can be emitted into space within the range of the atmospheric window, in order thus to obtain radiation cooling.

Furthermore, the increased transmission of the coating 200 in the visible range results at the same time in the sunlight incident on the cooling device 100 being reflected in such a way that the visible sunlight passes through the coating 200, then strikes the reflection layer 120, in order then in turn to be reflected through the coating 200 and correspondingly reflected away from the metal substrate 110 and therefore also reflected away from the cooling device 100.

It is correspondingly possible for heat, which is to be discharged as blackbody radiation or as heat radiation and which is introduced into the metal substrate 110, to be emitted through the atmospheric window even under solar radiation, the visible light being radiated in by the sun correspondingly being of no importance or being only of little importance.

The ceramic particles 220 and in particular the provision of the ceramic particles 220 in the form of silicon dioxide or hafnium oxide makes it possible to remove the heat provided at the metal substrate 110 from said metal substrate and to discharge it again by way of the ceramic particles within the wavelength range of the atmospheric window. It is correspondingly possible for heat always to be emitted from the metal substrate 110. The occurrence of solar radiation does not cause any supply of heat, or any noteworthy supply of heat, to the metal substrate 110 here.

In this way, the metal substrate 110 with the correspondingly applied coating 200 makes it possible to have the effect that, for example, when constructing a roof or when constructing a heat exchanger, the medium adjoining the metal substrate 110, for example air or a cooling medium, is kept at a temperature below the ambient temperature. This makes it possible to provide passive radiation cooling.

By virtue of the use of the metal substrate 110, it is possible to construct from the cooling device 100 a load-bearing structure, for example a self-supporting structure, in the sense that, for example, a cooling element in the form of a radiator or a cooling element in the form of a roof or a roof element can be formed from the cooling device 100. On account of the use of the metal substrate, it is possible for such an element to be bent out of or assembled directly from the cooling device. The cooling device itself is easy to machine and can be machined in the same way as metal sheets or metal plates are to be machined. In particular, the cooling device may be welded, sawed, bored, ground, adhesively bonded etc., in order to make it possible to use the cooling device to construct structures directly.

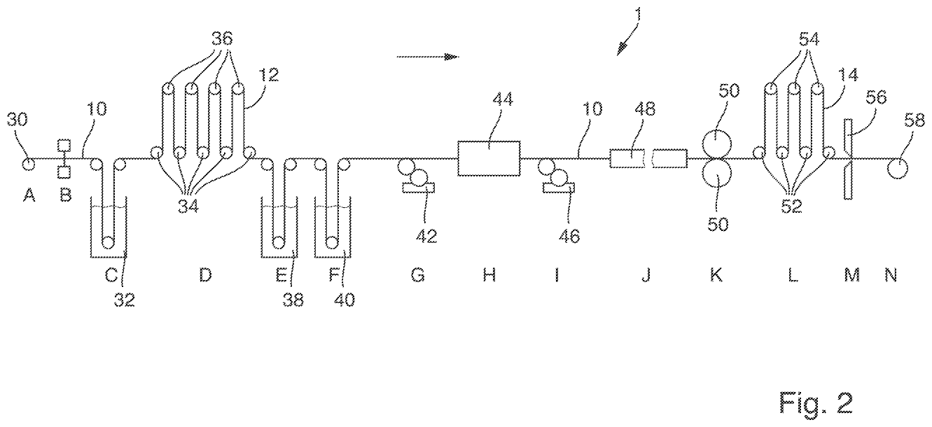

FIG. 2 schematically shows a production line 1 for producing a cooling device, as was described in relation to FIG. 1. The production line 1 will be described below taking into account the individual processing positions, which are denoted by the letters.

Provided at the first position is an unwinding device A, into which a roll 30 or a “coil” with a metal sheet or metal strip wound up on it can be loaded, and by way of which the metal sheet that is wound up on this roll 30 can be unwound for further use in the production line 1.

In an embodiment, which produces a cooling device 100 having the properties and advantages described above, it is possible to provide the metal sheet for example in the form of an aluminum sheet, which can be inserted into the unwinding device A in a state in which it is wound up on the roll 30 and correspondingly can be unwound by the unwinding device A.

A joining device B, by means of which a preceding metal sheet can be joined to a subsequent metal sheet, is provided downstream of the unwinding device A. This can be important, for example, if the intention is to achieve continuous production and accordingly, after a preceding roll 30 of the metal sheet that was inserted in the unwinding device A has been completely machined, to have the unwinding device A unwind a subsequent roll 30 of metal sheet, and accordingly to join the end of the metal sheet of the preceding roll 30 to the start of the subsequent roll 30. In this way, it is possible to produce an endless sheet, as it were, by attaching metal webs together, as a result of which a continuous production process can be correspondingly achieved.

The joining of the end of the metal strip unwound in the unwinding device A to the start of a metal strip inserted thereafter in the unwinding device A can be achieved for example by welding the end of a strip to the start of a new strip. Such a joining device B is also referred to as a stitcher/welder.

A cleaning device C, by means of which the metal strip 10 unwound by the unwinding device A is cleaned, is provided at the subsequent processing position. In this respect, in the cleaning device C the metal strip 10 can pass through a cleaning bath 32, in order thus to clean the metal strip 10. The cleaning may have the effect for example of removing dust and grease from the metal strip 10. This improves the reflectivity of the metal strip 10 and the subsequent processing steps, such as in particular a coating operation, can be prepared for and improved.

The cleaning of the metal strip 10 also makes it possible to homogenize the surface of the metal strip 10, which provides the basis for consistent quality of the coating and of further processing steps.

The cleaning bath 32 may be provided for example in the form of a suitable acid and/or suitable surfactants and/or a suitable alkaline solution and/or other cleaning media, which are adapted both to the material of the respective metal strip 10 and to the expected soiling of the metal strip 10. It is also possible for the metal strip to pass through multiple cleaning baths in succession.

A storage device D, in which the metal strip 10 is stored so as to form loops 12, is provided downstream of the cleaning bath 32 or downstream of the cleaning device C in the exemplary embodiment shown of the production line 1. The guidance of the metal strip 10 in loop form, which results in the loops 12, is achieved in the storage device D by rollers 34 and opposing rollers 36, which are respectively arranged spaced apart from one another perpendicularly to the conveying direction.

Correspondingly, in the region of the storage device D, it is possible to store a predefined length of the metal strip 10 or to accommodate it in the loops 12, with the result that, when the roll 30 inserted in the unwinding device A has ended and a new roll 30 has been inserted into the unwinding device A and the intention is then correspondingly to join the end of the previous strip to the start of the new strip in the joining device B, a continuous strip flow downstream of the storage device D can nevertheless be achieved in that the metal strip 10 accommodated in loop form in the loops 12 of the storage device D can be guided continuously into the downstream regions of the production line 1.

To that end, when the joining device B has to join an end of a strip to a start of a new strip, the metal strip 10 is held in the region of the joining device B and the metal strip 10 wound up in the loops 12 is released for the downstream processing steps by virtue of a movement of the opposing rollers 36 toward the rollers 34.

The number of loops 12 that is shown in the storage device D in FIG. 2 can be adjusted with a greater number of loops or a smaller number of loops and a greater distance between two oppositely situated rollers 34, 36 or a smaller distance between two rollers 34, 36 which follow one another depending on the flow speed of the metal strip 10 and depending on the time required in the region of the joining device B such that, taking into account a corresponding safety margin, a continuous flow of the metal strip 10 downstream of the storage device D during normal operational procedure can be ensured.

An electropolishing device E, in which the metal strip 10 discharged from the storage device D passes through a polishing bath 38 in which electropolishing takes place, is provided downstream of the storage device D. The electropolishing in the electropolishing device E makes it possible to improve the surfaces of the metal strip 10 even further and to provide, for example, high reflectivity on the surface of the metal strip 10 treated in the electropolishing device E.

The electropolishing in the electropolishing device E takes place in a manner known per se by way of an electrochemical material removal method using an external current source. The electrolyte used for this is correspondingly again matched to the material of the metal strip 10 such that, in the course of the electropolishing process in the electropolishing device E, the desired result of a metal strip 10 polished in this way is achieved. Depending on the material used for the metal strip 10, the electrolytes to be used are then different.

During the electropolishing process, the metal on the surface of the metal strip 10 is anodically removed, with the result that the metallic workpiece in the form of the metal strip 10 forms the anode of an electrochemical cell.

Downstream of the electropolishing device E, the cleaned and polished metal strip 10 is dipped in a silver-plating device F comprising a silver-plating bath 40 and is provided with a silver plating in said silver-plating bath. The silver-plating device F correspondingly makes it possible to apply a reflection layer to the metal strip 10.

The silver plating or the reflection layer applied to the metal strip 10 is in turn dependent on the material properties of the metal strip. In an exemplary embodiment, for example, the metal strip 10 can be dipped into a silver electrolyte, for example potassium silver cyanide, in the silver-plating device F and in the silver-plating bath 40 of the silver-plating device F, with in that case a silver coat being deposited by applying an electrical voltage to the surfaces of the metal strip 10. In other words, the metal strip 10 is subjected to galvanization in order correspondingly to obtain a galvanic silver coat.

The method step of silver plating can also be omitted if the metal strip 10 polished in the electropolishing device E has an appropriately high surface quality. In other words, it is possible to dispense with the silver plating if the surface provided by the cleaned and polished metal strip 10 already sufficiently reflects visible sunlight. Whether or not this is the case can also depend on the material used for the metal strip 10.

A prime coat is applied to at least one side of the metal strip 10 in a priming device G downstream of the silver-plating device F, it being the case in the exemplary embodiment shown that the priming device G is provided by a roll applicator 42, by means of which the prime coat can be applied to the bottom side, shown in FIG. 2, of the metal strip 10.

The prime coat serves to improve the application behavior or the adhesion between the coating which is to be applied later and the mirror-coated metal strip 10. It is also possible here, depending on the materials used and in particular on the material applied in the silver-plating device F, to select the prime coat such that it is easily possible to subsequently apply the coating.

A curing device H, by means of which the previously applied prime coat is cured, is provided downstream of the priming device G. This may be achieved for example in that a curing oven 44 is provided in the curing device H, making it possible to have the effect that the prime coat is thermally cured.

Downstream of the curing device H, the now mirror-coated metal strip 10 provided at least on one side with a cured prime coat then passes through a coating device I, in which a further roll applicator 46 applies a coating to that side of the metal strip 10 that is provided with the mirror coat and the prime coat.

The coating, which is applied to the metal strip in the coating device I by the roll applicator 46, may be for example a mixture of ceramic particles, such as silicon dioxide particles (SiO2), and a precursor of a thermosetting polymer.

The polymer and the ceramic particles can have similar refractive indices in the visible wavelength range, whereas the refractive indices of these materials within the range of the atmospheric window, that is to say wavelengths of between 8 and 10 micrometers, are considerably different.

Downstream of the coating device I, the metal strip 10 provided with the coating passes through a coating curing means J, in which a curing oven 48 is provided, for example. In other words, the metal strip 10 provided with the coating in the coating device I now passes through a curing oven 48, by means of which the coating and in particular the polymer can cure.

An embossing device K, which applies an embossment by means of two embossing rollers 50 to the metal strip 10 provided with the coating, may be provided downstream of the coating curing means J.

The application of a appropriate structuring makes it possible to further improve the cooling power of the cooling device in the form of the metal strip 10 provided with the coating, and as a result the optical properties of the surface can be adapted to the respective use. An outlet storage device L serves in turn to place the now coated metal strip 10 around rollers 52 and opposing rollers 54 in loops 14, in order to be able to accommodate the metal strip 10 in a continuous process, when a strip coil 58 is completely wound up in a downstream winding-up device N and has to be taken out of the winding-up device N again in order to make space for a new roll 58.

In order to separate the metal strip 10, if in the winding-up device N the desired thickness of the roll 58 is reached or the desired length of strip has been wound onto the roll 58, a separating device M is provided, which allows the metal strip 10 to be cut through by a corresponding blade 56.

By means of the production line 1, it is correspondingly possible to guide a metal strip from an unwinding device A through a cleaning bath, a polishing bath and a silver-plating bath in order then to provide at least one side of the metal strip 10 with a coating. The coating has selective absorption to the extent that, within the atmospheric window having a wavelength for example of 7-13 micrometers, it has above 60 percent absorption, or above 80 percent absorption, or above 90 percent absorption. At the same time, the transparency of the coating in the visible wavelength range of between 400 nm and 1200 nm is above 80 percent, or above 90 percent, or above 95 percent.

This makes it possible to have the effect that light in the visible range is reflected at the mirror coat, but conversely that light within the range of the atmospheric window is absorbed by the coating and then re-emitted.

The cooling device 100 produced in this way can correspondingly be produced continuously and—as it were—in an endlessly long form in the production line 1. Correspondingly, it is possible to produce one-piece structures having very different dimensions from the cooling device 100 produced by means of the production line 1. Furthermore, it is possible to achieve cost-effective mass manufacture, which makes it possible to widely use the cooling device.

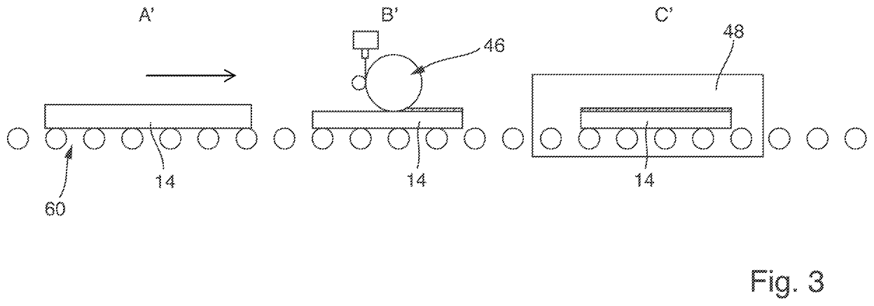

In the alternative embodiment shown in FIG. 3, in FIG. 3 it is also possible for individual metal plates 14 to now be coated instead of the continuous production, described in relation to FIG. 2, of a metal strip.

In this respect, for example, in a first step a pretreatment A′ is performed and an uncoated metal plate 14 is transported and cleaned and pretreated on a roller table 60, for example. The metal plate 14 may also be polished or electropolished, for example. After this, it is also possible to apply a reflection layer.

In the second step, a coating B′ is then performed, the coating being applied to one side of the metal plate 14 by means of a roll applicator 46. The coating may be the mixture, already described in relation to FIG. 2, of a thermosetting polymer or of a thermosetting polymer matrix and ceramic particles for example in the form of silicon dioxide.

After the coating, in step B the metal plate 14 then provided with the coating is passed to curing C′ in a curing oven 48 in order to cure there, similar to what was described in relation to FIG. 2.

In a further embodiment, for the coating it is also possible for a thermoplastic polymer, which is mixed with ceramic particles, to be applied instead of a thermosetting polymer or a thermosetting polymer matrix.

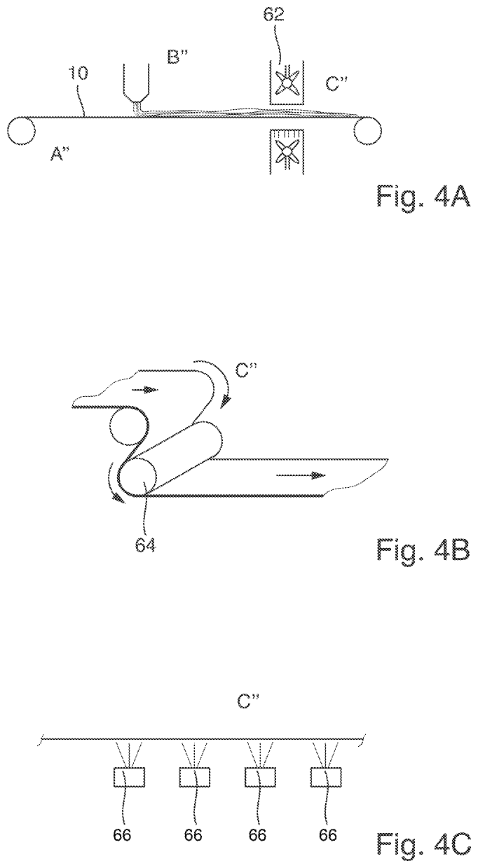

This thermoplastic polymer may, as is shown for example in FIG. 4A, be applied to a metal strip 10 pretreated in a pretreatment A″ for coating B″ purposes in a hot, molten state, it then being the case that either the polymer can be spread on or sprayed on, or the metal strip can be dipped into the hot polymer, or the polymer can be extruded.

The thermoplastic polymer applied in this way can then be cured C″ by being cooled down, for example as a result of cooling via fans 62, or by the cooling rollers 64 shown in FIG. 3B, or by spraying on a cooling medium from cooling nozzles 66, as is shown in FIG. 4C.

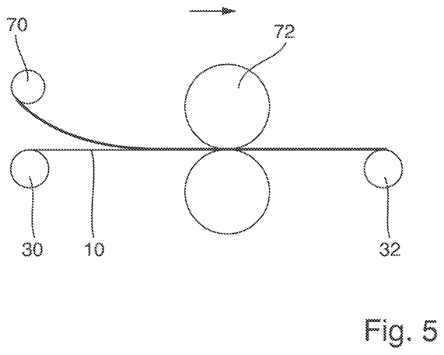

In a further embodiment, it is possible, as is shown in FIG. 5, for an already prepared coating film 70 to be laminated onto the prepared metal strip 10. The metal strip 10 may be cleaned, polished and provided with a reflection layer before the coating film 70 is laminated on.

In the process, the coating film 70 is consolidated with the metal strip 10 for example in a laminating roller 72 such that it is fixedly connected to the metal strip 10 by virtue of the rolling step or further mechanical consolidation.

The coating film 70 may already be pre-produced in this way, and correspondingly likewise comprise a polymer matrix in which the ceramic particles are incorporated.

In order to improve the stability and longevity of the polymer coating, it is also possible to perform multiple steps of coating the metal strip 10 or metal plates 14 with the polymer, with the result that multiple layers, applied one on top of another, of the polymer are correspondingly connected to the metal strip.

In further advantageous embodiments, the curing of a polymer can also be achieved by irradiation with ultraviolet light, for example.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Production line
10 Metal strip
12 Loop
14 Metal plate
100 Cooling device
110 Metal substrate
120 Reflection layer
200 Coating
210 Polymer matrix
220 Ceramic particles
30 Roll
32 Cleaning bath
34 Roller
36 Opposing roller
38 Polishing bath
40 Silver-plating bath
42 Roll applicator
44 Curing oven
46 Roll applicator
48 Curing oven
50 Embossing roller
52 Roller
54 Opposing roller
56 Blade
58 Roll
60 Roller table
62 Fan
64 Cooling roller
66 Cooling nozzle
70 Coating film
72 Laminating roller
A Unwinding device
B Joining device
C Cleaning device
D Storage device
E Electropolishing device
F Silver-plating device
G Priming device
H Curing device
I Coating device
J Coating curing means
K Embossing device
L Output storage device
M Separating device
N Winding-up device
A′, A″ Pretreatment
B′, B″ Coating
C′, C″ Curing

1. A cooling device for providing passive radiation cooling, the cooling device comprising:
a base substrate, and
a coating arranged on the base substrate and configured to absorb light of certain wavelength ranges,
wherein the base substrate is a metal substrate.

2. The cooling device as claimed in claim 1, wherein the metal substrate is in a form of a metal sheet, or a metal plate or a metal strip, wherein the metal substrate comprises aluminum, or an aluminum alloy, or iron, or an iron alloy, or steel, or copper, or a copper alloy.

3. The cooling device as claimed in claim 1, further comprising a reflection layer arranged between the metal substrate and the coating, the reflection layer having high reflectivity at least at wavelengths in the visible range, or at wavelengths in a range of from 400 nm to 1200 nm.

4. The cooling device as claimed in claim 3, wherein the reflection layer comprises a silver plating in the form of a mirror coat, and the silver plating is arranged directly on the metal substrate between the metal substrate and the coating.

5. The cooling device as claimed in claim 1, wherein the absorption of the coating at wavelengths within an atmospheric window, or at wavelengths of from 7 μm to 13 μm, is at least 60%, or above 80%, or above 90%.

6. The cooling device as claimed in claim 1, wherein the transparency of the coating at wavelengths in the visible range, or at wavelengths in a range from 400 nm to 1200 nm, is at least 80%, or at least 90%, or at least 95%.

7. The cooling device as claimed in claim 1, wherein the coating comprises particles, and a polymer or a polymer precursor.

8. The cooling device as claimed in claim 7, wherein the particles comprises ceramic particles, and the polymer or the polymer precursor comprises thermoplastic or thermosetting polymer.

9. The cooling device as claimed in claim 7, wherein the particles comprises silicon dioxide or hafnium oxide, and the polymer comprises polymethyl acrylate, or TPX, or polymethylmethacrylimide.

10. The cooling device as claimed in claim 7, wherein a mixing ratio of the particles in the polymer or the polymer precursor ranges from 1% to 15%.

11. The cooling device as claimed in claim 7, wherein the particles and the polymer or the polymer precursor have the same or similar refractive indices at wavelengths in the visible range, or at wavelengths of from 400 nm to 1200 nm, and the particles and the polymer or the polymer precursor have divergent refractive indices at wavelengths within the atmospheric window, or at wavelengths of from 7 μm to 13 μm.

12. The cooling device as claimed in claim 1, wherein the coating comprises an embossment.

13. The cooling device as claimed in claim 1, wherein a further metal layer is arranged between the metal substrate and the reflection layer, the metal layer comprising zinc, or a zinc alloy, or aluminum, or an aluminum alloy, or tin, or a tin alloy.

14. A method for producing a cooling device, comprising the following steps:
providing a metal substrate;
preparing the metal substrate for subsequent processing; and
coating the metal substrate with a coating which absorbs light of certain wavelength ranges.

15. The method as claimed in claim 14, wherein, before the metal substrate is coated, a reflection layer is provided on the metal substrate by applying a silver plating to the metal substrate, and the coating is applied to the reflection layer.

16. The method as claimed in claim 14, wherein the metal substrate is cleaned in a cleaning device before it is coated and/or is polished in an electropolishing device before it is coated.

17. The method as claimed in claim 14, wherein the coating is applied to at least one side of the metal substrate by a roll applicator or a coating-bar applicator or an extruder or a laminator.

18. The method as claimed in claim 14, wherein the metal substrate is provided in the form of a metal strip, and the metal strip comprises aluminum, or iron, or copper, or an aluminum alloy, or an iron alloy, or a copper alloy, and a joining device for joining metal strips that follow one another is provided.

19. The method as claimed in claim 14, wherein the metal strip coated with the coating is provided with an embossment in an embossing device.

20. The method as claimed in claim 14, wherein the metal substrate is provided in the form of a coated metal strip, and the metal strip comprises zinc, or a sinc alloy, or aluminum, or an aluminum alloy, or is coated with tin or a tin alloy, or is coated with magnesium or a magnesium alloy.
